(19) United States
(12) Patent Application Publication
(10) Pub. No.: US 2012/0324024 A1
(43) Pub. Date: Dec. 20, 2012

(54) SYSTEM AND METHOD FOR CONTROLLING AND SYNCHRONIZING INTERFACES REMOTELY

(75) Inventors: Jonathan Benassaya, Menlo Park, CA (US); Laurent Cerveau, Viroflay (FR); Jean Lafleur, Paris (FR)

(73) Assignee: MILESTONE PROJECT INC., San Francisco, CA (US)

(21) Appl. No.: 13/495,710

(22) Filed: Jun. 13, 2012

Related U.S. Application Data
(60) Provisional application No. 61/496,954, filed on Jun. 14, 2011.

(51) Int. Cl. G06F 15/16

(52) U.S. Cl. 709/206; 709/248

(57) ABSTRACT

A processing device pairs an emitting device with a recipient device to synchronize media content between the emitting device and the recipient device. The processing device receives an instruction from the emitting device, the instruction comprising a parameter and a value for the media content, and forwards, the instruction to the recipient device for execution on the media content. The processing device receives a notification from the recipient device indicating a status of the execution of the instruction.

### RELATED APPLICATIONS

This application is related to and claims the benefit of U.S. Provisional Patent Application No. 61/496,954 filed on Jun. 14, 2011, the contents of which are hereby incorporated by reference.

### TECHNICAL FIELD

This disclosure relates to the field of media consumption, and in particular, to controlling and synchronizing interfaces remotely.

### BACKGROUND OF THE INVENTION

There are more and more connected devices in the world every day. Storage synchronization between interfaces of these devices has existed for several years, but the technologies for media consumption synchronization are just emerging. Certain synchronization technologies enable a viewer to watch a video in a synchronized way on multiple devices from the same manufacturer or service provider. However, these technologies are not compatible across other platforms, and are generally restricted to a specific set of devices. No current technology is compatible across all platforms. Furthermore, when playing a video on a television from a tablet computer, for example, the content is streamed from the tablet to the television, so the viewer cannot move out of the player on the tablet in real time to write an email or share/like a video or post comments on the video on social networking sites. Yet, while watching television, people tend to engage in multiple activities such as browsing the Internet, or interact on social networking sites.

### SUMMARY OF THE INVENTION

A system and method are disclosed for controlling and synchronizing interfaces remotely. In one embodiment, a communication protocol module in a cloud platform pairs an emitting device with a recipient device to synchronize media content between the emitting device and the recipient device. Pairing the emitting device with the recipient device may include receiving a pairing instruction from the emitting device, where the pairing instruction indicates the recipient device, and forwarding the pairing instruction to the recipient device. In one embodiment, the emitting device and pairing device are provided by different manufacturers and need not be compatible other than supporting the communication protocol described herein. The emitting device and pairing device also need not be connected to the same local network (although they may be), but may be connected to a wide area network, such as the Internet. After pairing, the communication protocol module may receive an instruction from the emitting device, where the instruction includes a parameter and a value for the media content. The communication protocol module may forward the instruction to the recipient device for execution on the media content, and in response receive a notification, from the recipient device, indicating a status of the execution of the instruction.

In one embodiment, the instruction includes a command to set a parameter to a value for the media content on the recipient device. In another embodiment, the instruction includes a request to determine if the parameter is set to the value for the media content on the recipient device. The parameter may include, for example, a format of the media content that is based on a capability of the recipient device. Thus, if the capability of the recipient device is different from a capability of the emitting device, the format of the media content may be altered.

In one embodiment, if the instruction is successfully executed on the recipient device, the notification may include a status indicating that the parameter was set to the value for the media content. If the instruction is not successfully executed on the recipient device, the notification may include an error message indicating that the parameter was not set to the value for the media content. In such a case, the communication protocol module may attempt to resend the instruction.

### BRIEF DESCRIPTION OF THE DRAWINGS

The present invention will be more readily understood from the detailed description of exemplary embodiments presented below considered in conjunction with the attached drawings, of which:

FIG. 1a is a block diagram of a system architecture for controlling and synchronizing a recipient device from an emitting device remotely through a Wide Area Network (WAN).

FIG. 1b is a block diagram of a system architecture for controlling and synchronizing a recipient device from an emitting device from the same Local Area Network (LAN).

FIG. 2 is a graphical representation of an exemplary communication protocol to control or synchronize the recipient device from the emitting device.

FIG. 3 is a flowchart illustrating a method for pairing one device to one or more other devices.

FIG. 4 is a flowchart illustrating a method for controlling or synchronizing one or more recipient devices from an emitting device.

FIG. 5 is a flowchart illustrating a method for managing errors that might occur during the execution of an instruction.

FIG. 6 is a flowchart illustrating a method for maintaining information in case the communication process is not fulfilled due to errors occur in the notification process

FIG. 7 is a block diagram illustrating a computer system, according to an embodiment.

### DETAILED DESCRIPTION OF THE INVENTION

Embodiments of the present invention provide a solution whereby users can consume content (e.g., video, audio, Internet) on one communicatively connected device (i.e., the emitting device) and export such content onto another device (i.e., the recipient device) in a synchronized way. Advantageously, users may continue consuming the content on the recipient device from the point they left it and access other applications and content on the emitting device, all while consuming the content on the recipient device. The user may also switch back to the emitting device and continuing consuming content from the point they left it on the recipient device. Consumption on the emitting device is uncorrelated to the recipient device. Therefore, this invention provides significant advantages over conventional technologies.

First, there is no restriction to the nature of the communicatively connected device, as long as it can conform to a shared communication protocol with another connected device. Therefore, the interface may be shared across devices from different manufacturers and/or service providers.

Second, the instructions sent by the emitting device to the recipient device are executed by the recipient device itself, rather than streamed from one device to the other. Therefore, while consuming some content on the recipient device, the user can perform other functions using the emitting device. The user can even exit the corresponding application, do something else on the emitting device, such as browsing Internet or checking emails, and then switch back to the corresponding application to seamlessly regain control of the recipient device. The emitting device thus acts similarly to a remote control, allowing the user to select devices for the consumption of content.

Third, there is a discovery and interaction process through both a LAN and a WAN. Devices do not need to be on the same local area network in order to be synchronized. Embodiments of the present invention allow a user to switch from a device at work, for example, to another device at home, or at any other location.

Fourth, viewing of specific content may be easier or more robust based on the recipient device. For example, a particular recipient device may have an internet connection with higher bandwidth or may have enhanced decoding and format capabilities as compared to the emitting device. By way of example and not limitation, the recipient device may be a fixed installation via Ethernet. As such, it may have higher capacities in terms of decoding or may be compatible with Flash for instance. Thus, for instance, a device that is not itself Flash compatible can control a Flash video on a separate Flash compatible device.

In order to control a recipient device from a separate emitting device, or to synchronize the consumption of content on several devices, an adapted communication protocol may be established between both devices. These devices may represent any type of communicatively connected devices such as mobile (e.g., smartphone or a tablet) or fixed (e.g., desktop computer, laptop, communicatively connected TV, communicatively connected media player or console).

As used herein, the term “communicatively connected” is intended to include any type of connection, whether wired or wireless, in which data may be communicated and also includes a connection between devices and/or programs within a single computer or between devices and/or programs on separate computers.

As used herein, the term “content” includes, without limitation, digital audio and video files containing information such as movies, television shows, news programs and other content. Content can take a variety of forms such as MPEG audio and video files and other compressed or uncompressed file formats, which will be known to one of ordinary skill in the art. In addition, embodiments of the present invention utilize a cloud storage platform for storing content. However, one having ordinary skill in the art will appreciate that the content may be stored locally on a hard drive or other network attached storage device without departing from the scope of the invention.

As used herein, the term “communication protocol” includes, without limitation, any suitable online communication standard such HTTP, XMPP, Websockets, Adobe Flash Socket, AJAX long polling, AJAX multipart streaming, TelNet, Forever Iframe, and JSONP polling.

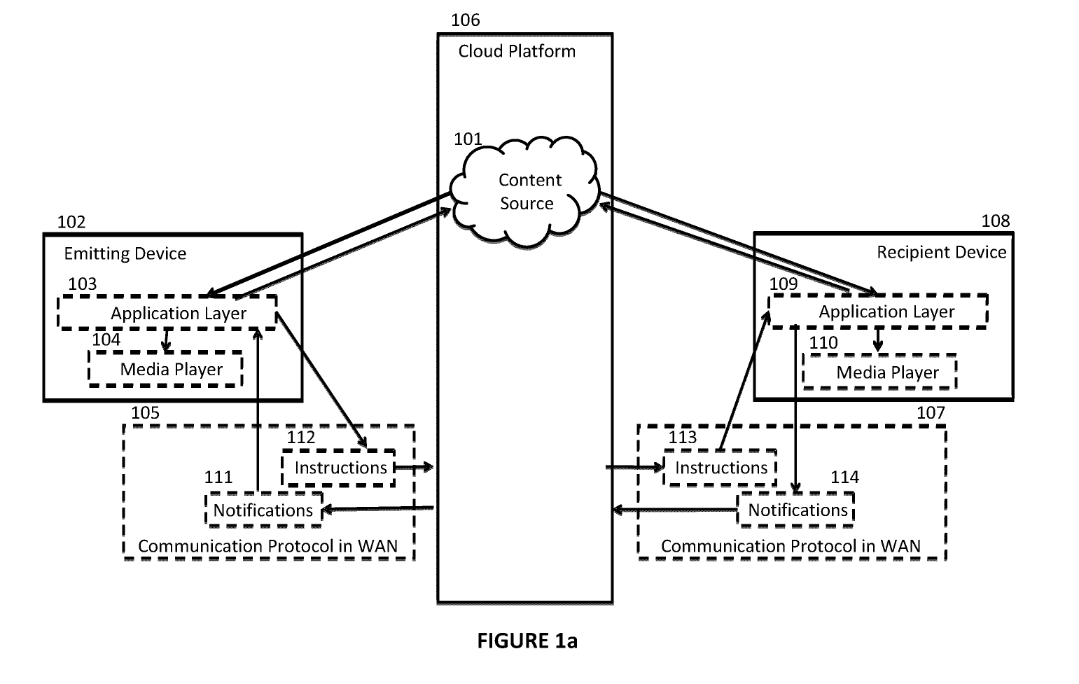

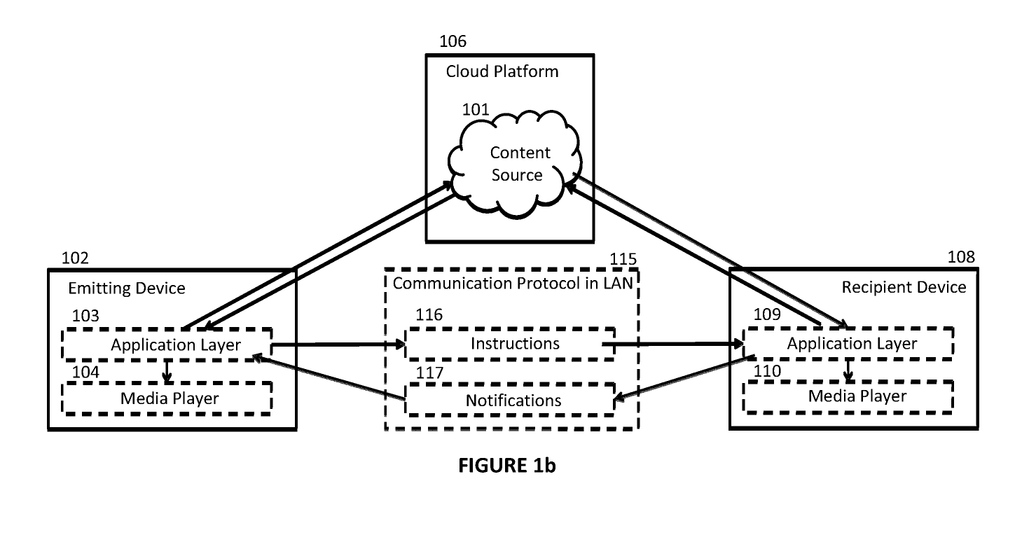

FIGS. 1a and 1b depict how the emitting device and recipient device can be communicating in two different embodiments of the invention. A communication protocol should enable both devices to send instructions and notifications. In one embodiment, the emitting device 102 may be the device that a user uses in order to consume media content either on the emitting device 102 itself or on a recipient device 108. The emitting device may also be used to control recipient device 108. FIG. 1a depicts how devices may be communicating in one embodiment of the invention in which both devices are connected to a wide area network (WAN), such as the Internet, whether they are on the same local area network (LAN) or not. FIG. 1b depicts an embodiment of the present invention in which both devices are in the same LAN with a communication protocol working in LAN.

An application layer 103 on the emitting device can request a third party service, such as content source 101, in order to access media content. The application layer 103 may represent any type of software, including but not limited to application software. The application layer 103 can control a media player 104 of the emitting device 102, which may be used to consume the content. The media player 104 may represent a video player, a music player, or an Internet browser, among others. With this setting, the user can consume the content he or she selected in the application layer 103 on the emitting device 102. In order to export this experience to another communicatively connected device (e.g., recipient device 108), the application layer 103 may comprise some communication protocol capabilities. Similarly, the recipient device 108 may include an application layer 109, which may represent any type of software or application software among others. Again, this application layer 109 on the recipient device 108 can control a media player 110 of the recipient device 108. The media player 110 may represent a video or music player, or an Internet browser, among others.

The application layer 109 may include the same communication protocol capabilities as application layer 103. The application layer 103 may be able to send instructions 112 and receive notifications 111 through the communication protocol 105. Similarly, the application layer 109 may be able to receive instructions 113 and send notifications 114 through the communication protocol 107. In another embodiment, both application layers 103 and 109 may have similar abilities with both communication protocols 105 and 107. Both communication protocols 105 and 107 may be similar in one embodiment of the invention, but may be different in another embodiment. For example, the communication protocol 105 may use Telnet if the emitting device 107 is a tablet computer, and the communication protocol 107 may use Websocket if the recipient device 108 uses Javascript. In the description below, both communication protocols 105 and 107 will have the same structure, but the invention shall not be limited to this embodiment.

As the emitting device 102 and the recipient device 108 may not be in the same LAN, the communication protocol may be carried out via a cloud platform 106 or other third party device, such as a server. The cloud platform 106 may store all necessary information related to a user account, the devices attached, the preferred communication protocol for each device, and some other information on the user, the devices and their specificity, and the application layers on these devices. Furthermore, the communication protocol may optionally be encrypted or not. If encrypted, all devices and the cloud platform 106 may store all necessary information concerning the encryption and decryption protocols.

As depicted in the FIG. 1b, the communication protocol 115 can be carried out directly between the emitting device 102 and the recipient device 108 for synchronization speed reasons. The communication protocol 115 may receive instructions 116 from application layers 103 and 109 and provide notifications 117 to applications layers 103 and 109. The invention shall include all scenarios of communication protocols between an emitting device and several recipient devices, should the communication protocol be carried out via a cloud platform or not.

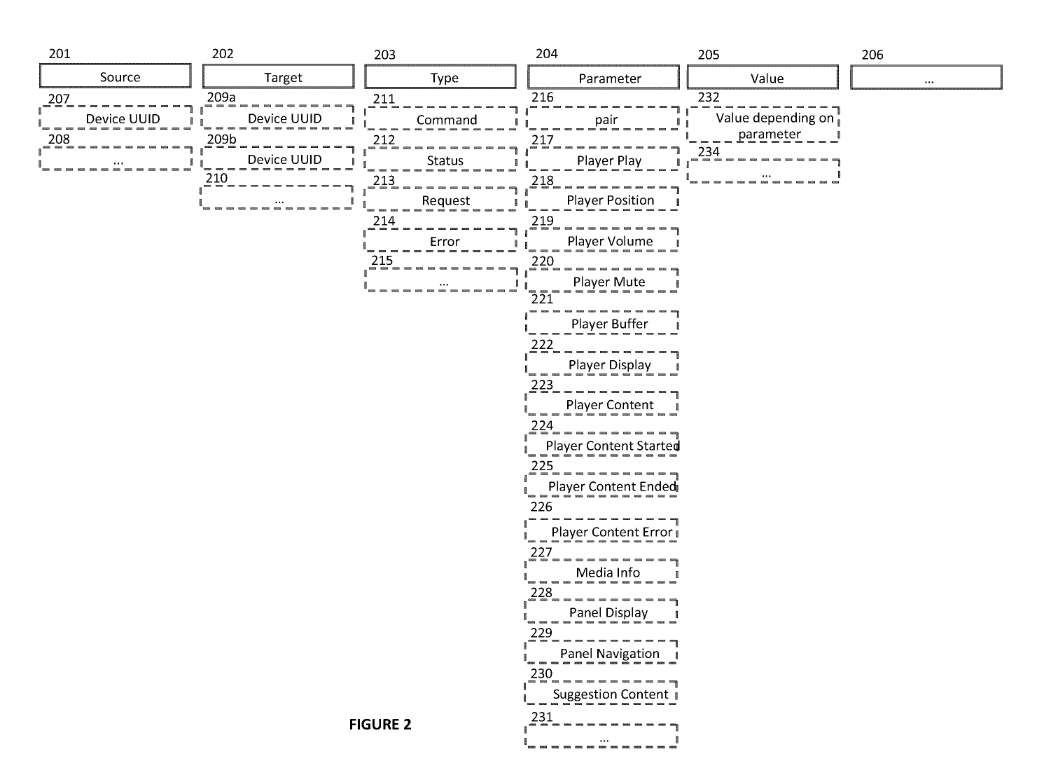

FIG. 2 illustrates an embodiment of the invention in which text or binary form may be used for the communication protocol. The invention does not limit itself to text or binary forms, and the communication protocol may comprise any suitable format, encrypted or not. If the communication protocol is encrypted, the application layers 103 and 109 (see FIGS. 1a and 1b) may include the tools to decrypt and encrypt the communications.

According to an embodiment of the invention, the instructions and notifications may contain five different categories of information: source 201, target 202, type 203, parameter 204, and value 205. Other embodiments of the invention may comprise another structure, different categories of information, different types, or different parameters and values. In another embodiment, there may be some other category 206 of information as well.

In one embodiment of the invention, the source category of information should contain the UUID of the emitting device 207, 208; similarly the target category of information may correspond to the UUID of the desired recipient device 209a or the UUIDs of the desired recipient devices 209a, 209b and 210, among others. The reason for integrating target device information is to allow the communication protocol to work with broadcasting and to allow multi-pairing, that is controlling and synchronizing several devices from a single device. The UUID may be defined from the unique UUID of the device, or the IP address, MAC address or other identifying attributes which will be known to one of ordinary skill in the art.

There may be four different types of instructions/notifications communicated between devices: command 211, status 212, request 213 and error 214. In other embodiments, there may be some other type 215 of instruction/notification. In this case, the “command” type 211 may be a request to set a parameter at a determined value. The “status” type 212 may be a notification to inform the new value of the parameter. The “request” type 213 may be an information request regarding the value of a parameter in the device receiving the instruction. Finally, the “error” type 214 may be a notification to say an error occurred, should it be among the reception of the communication, the sending of the notification, the availability of the information requested (the value of a parameter), in setting a value to a parameter, among others.

According to this embodiment of the present invention, the parameters may represent all controls of the recipient device's interface, should it be volume, display, media player, navigation abilities, or feature functionalities, among others. The parameters quoted from 216 to 231 are illustrations of such parameters:

The pair parameter 216 may be used to pair two devices together, which may imply that all controlling and synchronizing sessions may begin with a pairing instruction. Therefore, if the emitting device sends the instruction “Source: Device UUID 1/Target: Device UUID 2/Command/pair/”, it is requesting to pair with the desired device UUID 2 in order to control its interface or synchronize with it.

Player Play 217 may instruct the media player to play the content included in the instruction. Therefore, the emitting device 102 (FIGS. 1a and 1b) may send to the recipient device 108 the instruction “Source: Device UUID 1/Target: Device UUID 2/Command/Player Play/Content ID”, in which the Content ID includes the information for the application layer 109 to find the content source and play the content on the media player 110. Once the application layer has found the content source and plays the content, it may send the notification “Source: Device UUID 2/Target: Device UUID 1/Status/Player Play/Content ID”.

Player Position 218 may instruct a media player to set a time marker within the content, especially in the case of music or video. For instance, sending the instruction “Source: Device UUID 1/Target: Device UUID 2/Command/Player Position/Position: Y %” may instruct the application layer 109 to set the position of the content at Y %, which may send back the following notification once done “Source: Device UUID 2/Target: Device UUID 1/Status/Player Position/Position: Y %”. Therefore, if a Player Position instruction 218 is sent with the instruction Player Play 217, the recipient device may directly play the content from the time marker requested, which can create some synchronized experience on several interfaces from a user experience perspective.

Some parameters may enable the setting of parameters such as Player Volume 219 to set the volume value, Player Mute 220 to mute the volume, Player Display 222 to set the video display either as Panscan, Letterbox or Automatic, Panel Display 228 and Panel Navigation 229 to make the panel appear and browse through it if such panel exists, and Suggestion Content 230 among others. This invention presents no limit to the parameters that may be set and one having ordinary skill in the art will recognize other appropriate parameters.

Other parameters may enable to exchange information, such as Player Buffer 221 to notify the value of the buffer when streaming content, Player Content 223 to notify which content is being played, Player Content Started 224 and Player Content Ended 225 to notify that the content has started playing and ended playing respectively, or Player Content Error 226 to notify that the content cannot be played on the recipient device for (possibly because of the content format), or Media Info 227 to show the information of the media. Similarly, there is no limit to the parameters that can be shared between devices and shared with the user on whichever device he or she wants. The values 232, 234 associated with these parameters may be stored in value category 205.

The information shared through the communication protocol enables the maintenance of the same level of information between the communicatively connected devices thanks to the notifications following all instructions. If Internet connectivity is lost for one of the devices, some error messages will enable the devices to restore information as soon as Internet connectivity is resumed.

FIGS. 1a and 1b distinguish the case when the emitting device and the recipient device are in the same LAN and when they are in separate LANs. However, the communication protocol when both devices are in the same LAN can still be carried out through the cloud platform 106.

The content is not streamed from the emitting device 102 to the recipient device 108. Instead, the recipient device 108 is instructed by the emitting device 102 to execute some operations. Executing operations may comprise, and not be restricted to, playing a video or music from a URL link or XML file, opening a URL link with the recipient device's native browser, among others. All operations may be executed by the application layer 109 of the recipient device 108, and thus the capacities of the application layer 103 of the emitting device 102 have no restrictions on the operations that can be done by the application layer 109. In other words, the application layer 109 in the recipient device 108 needs to have the capacity to execute the operations instructed. Application software on connected televisions or other connected devices may have the ability to browse the web or use the Internet to access different services. Therefore, the content displayed on both devices is independent. This implies that after sending instructions on the recipient device 108, the user can exit the application layer 103 to do something else on the emitting device 102 while continuing to view the content on the recipient device 108.

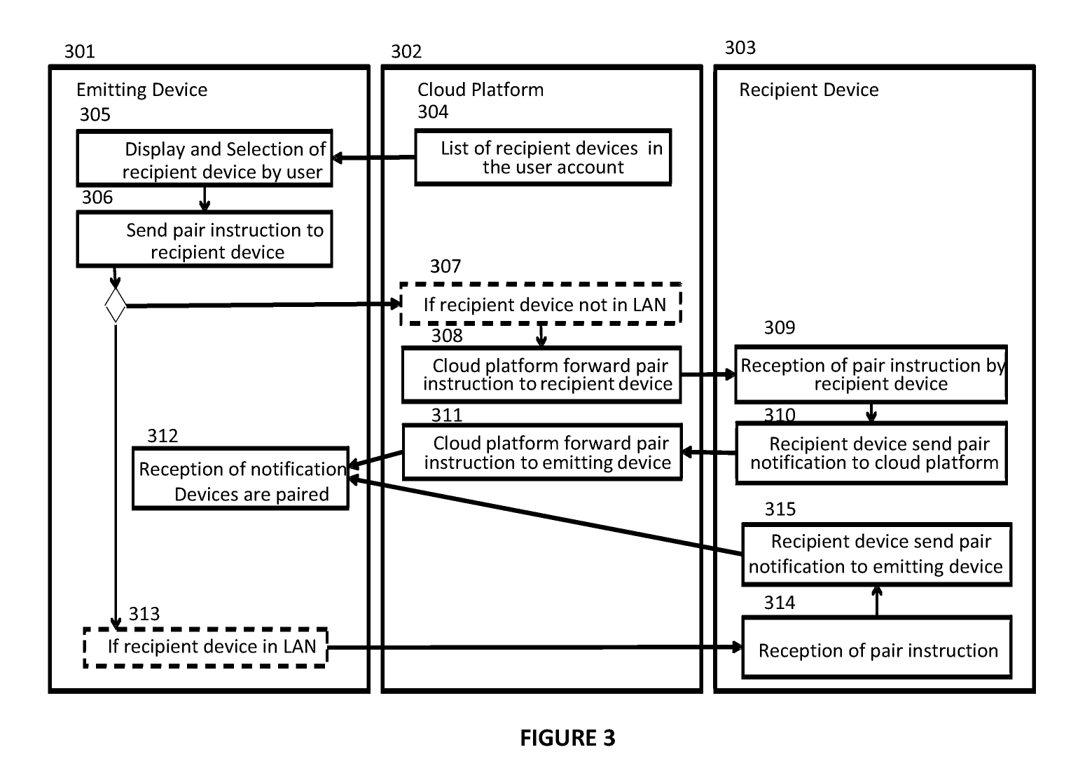

As detailed above, a controlling and synchronizing session may begin with a pairing process. FIG. 3 illustrates an embodiment of the methodology that may be used to pair two devices. This figure has only illustrative purposes and shall not limit the extent of the invention.

In one embodiment, each user may have several communicatively connected devices assigned to his or her account. In one embodiment of the invention, when trying to pair one device to another, the emitting device 301 may send the pair instruction to the cloud platform 302 which forwards it to all devices connected to the account. In another embodiment of the invention, the user may choose the recipient device 303 from a list 304 of communicatively connected devices attached to the account, sent by the cloud platform. This list may present only the connected and available devices with the application layer up and running in a third embodiment of the invention, and may be displayed 305 to the user on the emitting device 301.

When selecting 305 the recipient device that the user intends to control or synchronize with, a pair instruction is sent 306 to the selected device 303. This instruction may be sent 307 to the cloud platform 302 and then forwarded 308 to the recipient device 303 in one embodiment of the invention, or the instruction may be sent directly 313 to the recipient device 303 if identified within the same LAN in another embodiment of the invention. Once the instruction is received 309, 314 by the recipient device 303, the recipient device 303 sends 310, 315 back a notification to the emitting device 301 via the cloud platform 32, or possibly directly to the emitting device 301 if in the same LAN.

In the case where a user wants to pair the emitting device 301 to several recipient devices, the process may remain the same for each embodiment of the invention. Each recipient device may send back a notification 312 to the emitting device. The emitting device 301 can then determine if all recipient devices are paired if it receives the notification of each device.

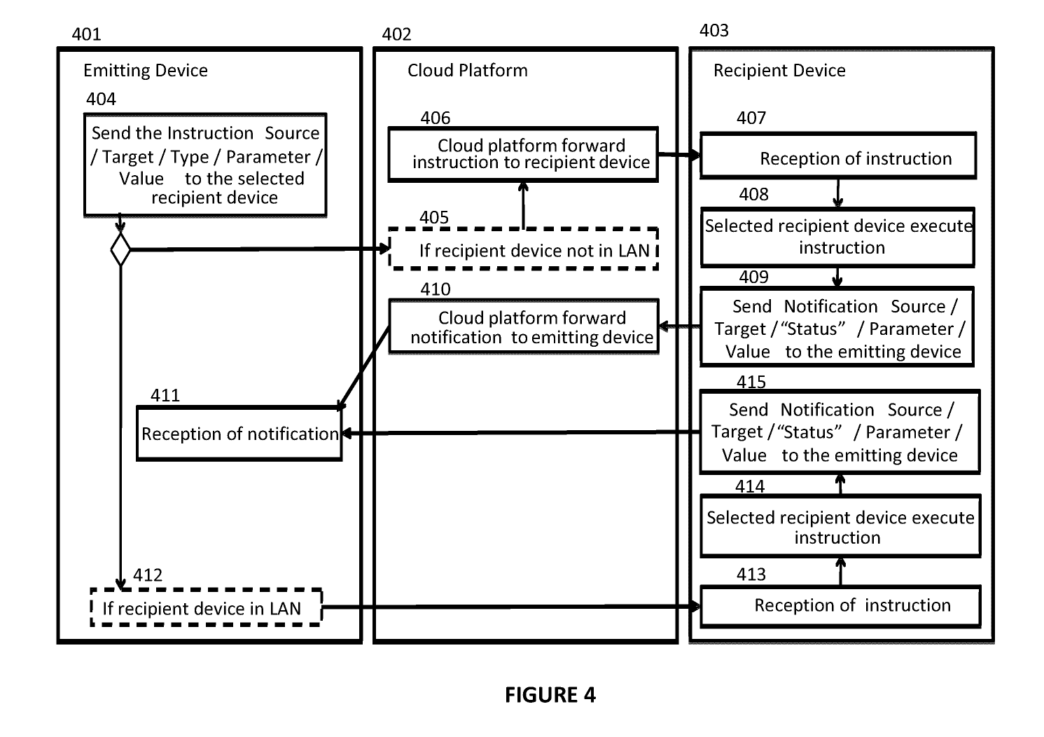

As detailed above, a controlling and synchronizing session may begin with a pairing process. After this pairing process, the emitting device may send 404 instructions to the recipient device to control or synchronize the experience on it (i.e. content to be viewed). FIG. 4 illustrates an embodiment of the methodology that may be used for such control and synchronization. This figure has only illustrative purposes and shall not limit the extent of the invention.

According to an embodiment of the present invention, after receiving 407, 413 an instruction from the emitting device 401, either via 405, 406 the cloud platform 402 or directly 412 if both devices are in the same LAN, the recipient device 403 executes 408, 414 the instruction. In another embodiment, one process (e.g., a synchronization process) in emitting device 401, receives the instruction from another process (e.g., an instruction process) in emitting device 401, and forwards 412 the instruction to recipient device 403. In another embodiment, one process (e.g., an instruction process) in recipient device 403 receives the instruction from emitting device 401 and forwards the instruction to another process (e.g., a synchronization process) in recipient device 403. Once the instruction is executed, the recipient device 403 sends 409, 415 the notification back to the emitting device. The notification may include the new value of the parameter in one embodiment of the invention, in order to ensure both devices have the same information. In one embodiment, cloud platform 402 may forward 410 the notification to emitting device 401, which receives 411 the notification. In another embodiment, one process (e.g., the synchronization process) in emitting device 403 forwards the notification to another process (e.g., a notification process) in emitting device 403.

In the case where the user wants to control or synchronize several recipient devices, the process may remain the same for each embodiment of the invention. Each recipient device may send back a notification. The emitting device can determine whether all recipient devices have executed the instruction if it receives the notification of each device.

The two methodologies described in FIGS. 3 and 4 may not be complete if no process would ensure that information is maintained between devices. For instance, an instruction may not be received by the recipient device, or a notification may not be received by the emitting device. Similarly, the execution of the instruction by the recipient device may not be successful, in which case the emitting device needs to be notified of the error encountered.

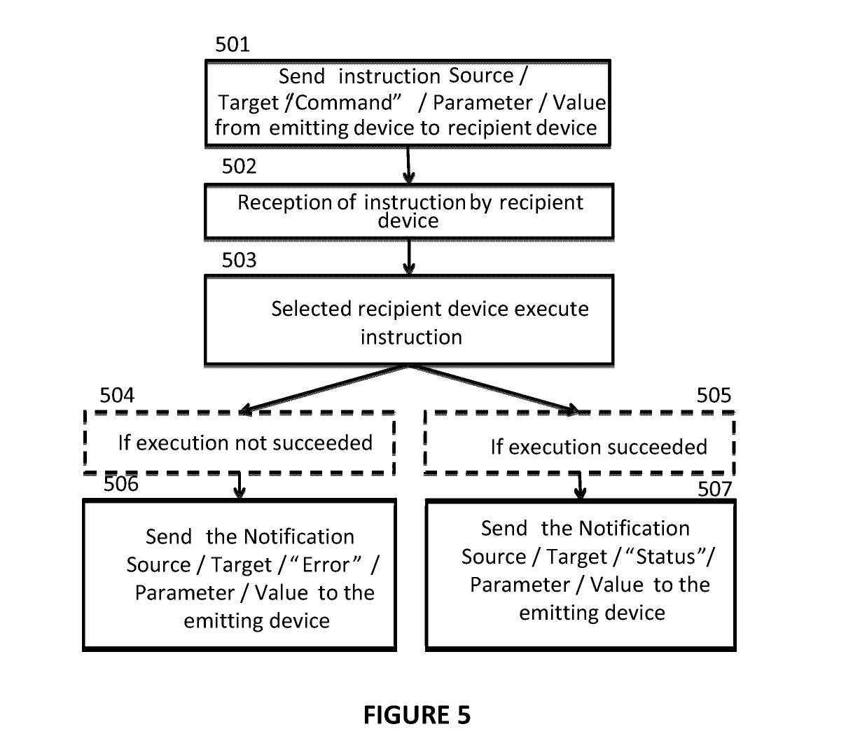

FIG. 5 illustrates an embodiment of the invention in which the type of notification depends on successful execution of the received instruction. In one embodiment, at block 501, the emitting device sends an instruction to the recipient device. The recipient device receives the instruction at block 502 and executes the instruction at block 503. If the execution is successful 505, at block 507, the recipient device sends a notification with the status of the instruction to the emitting device. If the execution is unsuccessful 504, then at block 506, an error notification may be sent to the emitting device. The value of the notification may contain information concerning the nature of the error.

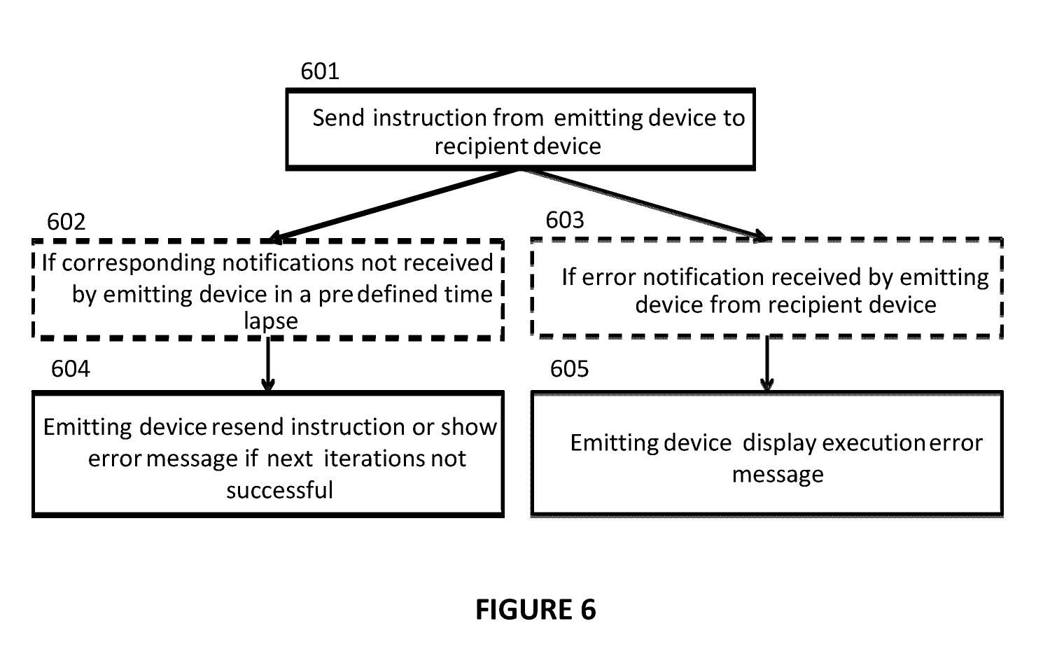

FIG. 6 illustrates an embodiment of the invention in which case the emitting device resend instructions when it does not receive notification from the recipient device of the instructions it sends. In one embodiment, at block 601, the emitting device sends an instruction to the recipient device. If an error notification is received 603, at block 605, an error message may appear on the emitting device interface if a certain number of successive unfruitful attempts for instruction is reached. Similarly, if the emitting device receives an error notification from the recipient device, the corresponding error message may be displayed on the emitting device, depending on the embodiment of the invention. In another embodiment of the invention, an instruction may be sent back for another attempt depending on the content of the error message. Indeed, if the execution is faulty because of losing Internet connection, and no corresponding notification is received within a predefined period of time 602, at block 604, it may be advantageous to automatically resend the same instruction. The instruction may be resent automatically until the Internet connection is restored. This process ensures the synchronization of information and its maintenance in the case of Internet connection loss. However, if the error message reports the content that was instructed to be played cannot be played on the recipient device because of absence of compatibility with the content format, it may be useless to automatically resend the same instruction, displaying a corresponding error message on the emitting device may be more relevant.

Therefore, in one previous embodiment of the invention, in which the user had a list of all his or her devices attached to his or her account, when trying to pair with a device without any active application layer, an error pair notification may be sent. Therefore, it might be more relevant to display only the list of devices with available and active application layers when the user wants to pair one device with another.

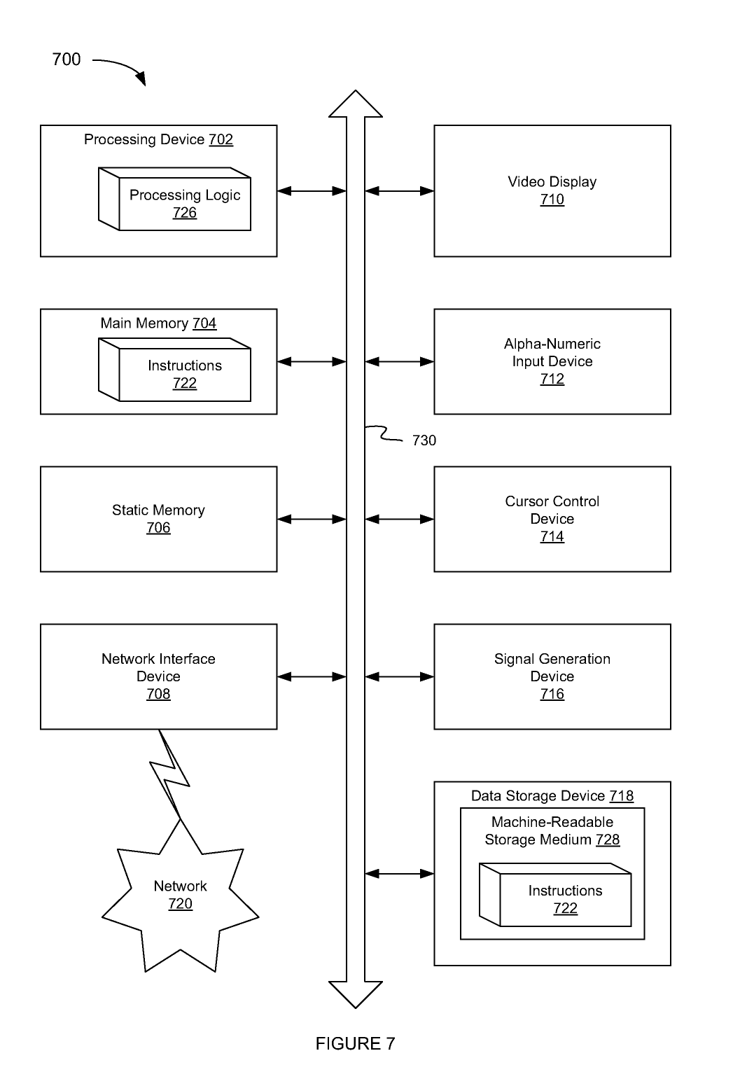

FIG. 7 illustrates a diagrammatic representation of a machine in the exemplary form of a computer system 700 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 700 may be representative emitting device 102, 301, or 401, recipient device 108, 303, or 403, or cloud platform 106, 302, or 402, described above.

The exemplary computer system 700 includes a processing device 702, a main memory 704 (e.g., read-only memory (ROM), flash memory, dynamic random access memory (DRAM) (such as synchronous DRAM (SDRAM) or Rambus DRAM (RDRAM), etc.), a static memory 706 (e.g., flash memory, static random access memory (SRAM), etc.), and a data storage device 718, which communicate with each other via a bus 730. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute processing logic 726 for performing the operations and steps discussed herein.

The computer system 700 may further include a network interface device 708. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

The data storage device 718 may include a machine-accessible storage medium 728, on which is stored one or more set of instructions 722 (e.g., software) embodying any one or more of the methodologies of functions described herein. The instructions 722 may also reside, completely or at least partially, within the main memory 704 and/or within the processing device 702 during execution thereof by the computer system 700; the main memory 704 and the processing device 702 also constituting machine-accessible storage media. The instructions 722 may further be transmitted or received over a network 720 via the network interface device 708.

The machine-readable storage medium 728 may also be used to store instructions to perform a method for controlling and synchronizing interfaces remotely, as described herein. While the machine-readable storage medium 728 is shown in an exemplary embodiment to be a single medium, the term “machine-readable storage medium” should be taken to include a single medium or multiple media (e.g., a centralized or distributed database, and/or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

What is claimed is:

1. A method comprising:
pairing an emitting device with a recipient device to synchronize media content between the emitting device and the recipient device;
receiving an instruction from the emitting device, the instruction comprising a parameter and a value for the media content;
forwarding, by a processing device, the instruction to the recipient device for execution on the media content; and
receiving a notification from the recipient device, the notification indicating a status of the execution of the instruction.

2. The method of claim 1, wherein pairing the emitting device with the recipient device comprises:
providing a list of communicatively connected devices to the emitting device;
receiving a pairing instruction from the emitting device, the pairing instruction indicating a selection of the recipient device from the list of communicatively connected devices; and
forwarding the pairing instruction to the recipient device.

3. The method of claim 1, wherein pairing the emitting device with the recipient device comprises:
receiving a pairing instruction from the emitting device, the pairing instruction indicating the recipient device; and
forwarding the pairing instruction to the recipient device.

4. The method of claim 1, wherein the instruction comprises a command to set the parameter to the value for the media content on the recipient device.

5. The method of claim 1, wherein the instruction comprises a request to determine if the parameter is set to the value for the media content on the recipient device.

6. The method of claim 1, wherein the parameter comprises a format of the media content that is based on a capability of the recipient device.

7. The method of claim 1, wherein if the instruction is successfully executed on the recipient device, the notification comprises a status indicating that the parameter was set to the value for the media content.

8. The method of claim 1, wherein if the instruction is not successfully executed on the recipient device, the notification comprises an error message indicating that the parameter was not set to the value for the media content.

9. The method of claim 1, wherein the emitting device and the recipient device are provided by different manufacturers.

10. The method of claim 1, wherein the emitting device and the recipient device are not connected to a same local network.

11. The method of claim 1, wherein the processing device is part of the emitting device.

12. The method of claim 1, wherein the processing device is part of the recipient device.

13. The method of claim 1, wherein the processing device is part of a third party device.

14. A system comprising:
a processing device;
a memory coupled to the processing device; and
a communication protocol module, executable by the processing device from the memory, to:
pair an emitting device with a recipient device to synchronize media content between the emitting device and the recipient device;
receive an instruction from the emitting device, the instruction comprising a parameter and a value for the media content;
forward the instruction to the recipient device for execution on the media content; and
receive a notification from the recipient device, the notification indicating a status of the execution of the instruction.

15. The system of claim 14, wherein pairing the emitting device with the recipient device comprises:
receiving a list of communicatively connected devices; and
receiving a pairing instruction from the emitting device, the pairing instruction indicating a selection of the recipient device from the list of communicatively connected devices; and
forwarding the pairing instruction to the recipient device.

16. The system of claim 14, wherein pairing the emitting device with the recipient device comprises:
receiving a pairing instruction from the emitting device, the pairing instruction indicating the recipient device; and
forwarding the pairing instruction to the recipient device.

17. The system of claim 14, wherein the instruction comprises a command to set the parameter to the value for the media content on the recipient device.

18. The system of claim 14, wherein the instruction comprises a request to determine if the parameter is set to the value for the media content on the recipient device.

19. The system of claim 14, wherein the parameter comprises a format of the media content that is based on a capability of the recipient device.

20. The system of claim 14, wherein if the instruction is successfully executed on the recipient device, the notification comprises a status indicating that the parameter was set to the value for the media content.

21. The system of claim 14, wherein if the instruction is not successfully executed on the recipient device, the notification comprises an error message indicating that the parameter was not set to the value for the media content.

22. The system of claim 14, wherein the emitting device and the recipient device are provided by different manufacturers.

23. The system of claim 14, wherein the emitting device and the recipient device are not connected to a same local network.

24. The system of claim 14, wherein the processing device is part of the emitting device.

25. The system of claim 14, wherein the processing device is part of the recipient device.

26. The system of claim 14, wherein the processing device is part of a third party device.

27. A non-transitory machine-readable storage medium storing instructions which, when executed, cause a data processing system to perform a method comprising:
pairing an emitting device with a recipient device to synchronize media content between the emitting device and the recipient device;
receiving, by a processing device an instruction from the emitting device for execution on the media content, the instruction comprising a parameter and a value for the media content; and
providing a notification to the emitting device, the notification indicating a status of the execution of the instruction.

28. The non-transitory machine-readable storage medium of claim 27, wherein pairing the emitting device with the recipient device comprises:
receiving a list of communicatively connected devices; and
receiving a pairing instruction from the emitting device, the pairing instruction indicating a selection of the recipient device from the list of communicatively connected devices; and
forwarding the pairing instruction to the recipient device.

29. The non-transitory machine-readable storage medium of claim 27, wherein pairing the emitting device with the recipient device comprises:
receiving a pairing instruction from the emitting device, the pairing instruction indicating the recipient device; and
forwarding the pairing instruction to the recipient device.

30. The non-transitory machine-readable storage medium of claim 27, wherein the instruction comprises a command to set the parameter to the value for the media content on the recipient device.

31. The non-transitory machine-readable storage medium of claim 27, wherein the instruction comprises a request to determine if the parameter is set to the value for the media content on the recipient device.

32. The non-transitory machine-readable storage medium of claim 27, wherein the parameter comprises a format of the media content that is based on a capability of the recipient device.

33. The non-transitory machine-readable storage medium of claim 27, wherein if the instruction is successfully executed on the recipient device, the notification comprises a status indicating that the parameter was set to the value for the media content.

34. The non-transitory machine-readable storage medium of claim 27, wherein if the instruction is not successfully executed on the recipient device, the notification comprises an error message indicating that the parameter was not set to the value for the media content.

35. The non-transitory machine-readable storage medium of claim 27, wherein the emitting device and the recipient device are provided by different manufacturers.

36. The non-transitory machine-readable storage medium of claim 27, wherein the emitting device and the recipient device are not connected to a same local network.

37. The non-transitory machine-readable storage medium of claim 27, wherein the processing device is part of the emitting device.

38. The non-transitory machine-readable storage medium of claim 27, wherein the processing device is part of the recipient device.

39. The non-transitory machine-readable storage medium of claim 27, wherein the processing device is part of a third party device.
